(19) United States
(12) Patent Application Publication
(10) Pub. No.: US 2007/0016868 A1
(43) Pub. Date: Jan. 18, 2007

(54) Method and a device for managing digital media files

(75) Inventor: Mikko Nurmi, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/479,953

(22) Filed: Jun. 29, 2006

(30) Foreign Application Priority Data
Jun. 30, 2005 (FI) 20055369

(51) Int. Cl. G06F 9/00

(52) U.S. Cl. 715/738; 715/835; 715/764; 715/864

(57) ABSTRACT

A method and an electronic device such as a digital camera or a camera phone for managing digital media files such as photo images. A user of the device may define link areas on the latest image captured via a camera to be automatically associated with the subsequently taken images. Thus image structures called image chains are formed while still continuing the image capturing process. Such chains can be navigated through during the image capturing process or later on.

### CROSS REFERENCE TO RELATED APPLICATIONS

This application claims priority under 35 USC §119 to Finnish Patent Application No. 20055369 filed on Jun. 30, 2005.

### TECHNICAL FIELD

The present invention relates to management of digital media files in electronic appliances. Especially the invention concerns devices equipped with cameras and organizing digital images in those.

### BACKGROUND OF THE INVENTION

The current trend in photography drives the evolution strongly towards digital imaging and respectively, traditional film cameras continuously lose their market share. One driving force of this phenomenon traces back to the recent rapid development of digital cameras due to the attained improvements in size, weight, and maximum achievable picture quality thereof. Moreover, resulting digital images can be cleverly stored in small-sized, affordable and relatively large capacity memory cards, and further, they can be easily moved between different electronic appliances such as desktop/laptop computers, PDAs (Personal Digital Assistant), mobile terminals, and printing devices, not to mention different applications like file management or image processing software, which are, no doubt, handy if not essential tools in organizing and editing the stored images. One major advantage of this so-called digitality also arises from somewhat effortless selection of images worth saving prior to fully consuming or developing the used storage medium such as a memory card unlike with the conventional film rolls.

As digital photographing is in many ways a more convenient imaging technique at least for an average user than the traditional film based methods, a tendency to increase the total amount of photos taken is one of the obvious consequences thereof. Thus the focus of manual work is now on image management rather than on initial image creation side. The devices capable of taking digital photos such as specific digital cameras or more versatile camera-equipped mobile terminals or PDAs typically bear just the necessary image management features such as automatic/manual image file naming and basic directory functions. However, as user interfaces are in most devices, due to the small size etc, quite limited and photos are taken rapidly in clumps, the resulting image files end up in a single default directory with a running number type code as an identifier for each independent image file. After image acquisition phase, the user is simply supposed to manually rename the files to better reflect the content thereof and organise them e.g. in proper sub-directories located in a desktop computer providing a more user-friendly Ul. This approach saves both design work and required hardware (memory and necessary electric or mechanic elements) from the camera devices that can be then kept simple, manufactured easier and sold with a lower price. Powerful image processing and management products are offered separately to the users that really are willing to pay for those. Therefore, it is common that many people take a significant number of photos during e.g. vacation trips or different social events like parties, but a correspondingly significant amount of the photos that are possibly not that vital are later forgotten to the original storage medium without proper naming and positioning. This is due to the lack of necessary tools, skills and/or time to further cultivate the rather undefined and bulky image file collection to content and time-divided compilations being also easily exploitable in the future; an issue, which happened automatically with the old days' camera equipment and truly physical photo albums.

### SUMMARY OF THE INVENTION

The object of the invention is to alleviate the aforementioned problems and provide a fast, logical and user-friendly linking and organizing technique for digital media files, especially image files, created by digital devices equipped with either internal or external camera. The object is achieved by a solution, where the user of an executing device may in connection with the image acquisition/creation, which in basic form refers to taking a number of photo images with a camera, link the images to form an image chain. A single image may act as or carry a link to one or several adjacent images in the chain. The user is provided with an image whereto he can visually define different link areas referring to other images. The links forming the chain determine the connections between the images and may also comprise optional information such as link direction etc that further define the type of the link. The actual form of the chain is ultimately defined by the links and their properties. The whole chain can be created from scratch by obtaining an image after another and determining the links between them, or a fresh image may be just linked to an existing, older chain (or in practise, to one or more images in that chain), or an independent older image(s) can be added to a newfound chain under construction. The images may be later waded through by utilizing the inter-image relations defined by the links.

In one aspect of the invention a method for linking a number of digital images together to form an image chain to be performed by an electronic device has,

obtaining a digital image captured via a camera, and

visualizing (displaying) the image on a display,

obtaining control information at least about a user-defined area on the visualized image,

specifying on the basis of the user-defined area a link area on the image,

obtaining another digital image, and

associating the link area with said another image.

In another aspect of the invention an electronic device capable of storing digital images comprises

a data input device for obtaining a digital image captured via a camera, and

a display for visualizing the image.

a control input device for receiving control information at least about a user-defined area on the visualized image, and

a processing unit configured to specify, on the basis of the user-defined area on the visualized image, a link area on the visualized image to be associated with at least one another image.

In a further aspect of the invention, a method for navigating a number of digital images to be performed by an electronic device, comprises

providing at least one image chain, said at least one image chain comprising multiple digital images and link information about a number of links between them, each image of the image chain being linked to at least one another image of the image chain,

visualizing a number of images belonging to the image chain, said number of images including a selected image determined by the device or chosen by the user,

visualizing the links between at least said selected image and other images belonging to the chain, and supplementary information relating to at least said selected image or a link having the selected image as one end point thereof,

obtaining control information from the user, and

specifying on the basis of the control information a second image of the chain to be selected subsequently.

Yet in a further aspect, an electronic device capable of storing digital images comprises

a data input device for obtaining digital images,

a display for visualizing digital images, and

a control input device for receiving control information from a user input, and

a processing unit configured to visualize through said display a number of digital images belonging to an image chain to a user, said image chain comprising multiple digital images and link information about a number of links between them, each image of the image chain being linked to at least one another image of the image chain and said number of images including a selected image determined by the device or chosen by the user,

further configured to visualize the links between at least said selected image and other images belonging to the chain, and supplementary information relating to at least said selected image or a link having the selected image as one end point thereof,

further configured to obtain control information from the user through said control input device, and

further configured to specify on the basis of the control information a second image to be selected subsequently.

Although the invention is herein described with an explicit reference to images, it may also be used for linking and organizing e.g. digital video signal comprising multiple images (so-called frames). In that case the links may extend either internally between frames of a single video clip or between several clips. In the latter option a single clip may be represented by an image, e.g. a frame taken from the clip or a dedicated one. Also different audio files may be represented by images and be thus organized according to the invention. Both with audio and video the process can be performed “real-time” as with the images while running the actual recorder application, i.e. a link can be defined after acquiring a link source file and before acquiring the link destination file.

The utility of the invention arises from a plurality of issues. First, using chains enables structured and organized contemplation of independent images belonging to a certain chain. The images can be retained in the preferred order such as a chronological and/or subject matter related one. Traversing through the images linked in chains is easier and faster than without any linkage as the user may, for example, conduct image searches through contexts created by the links between the images. This may even happen during the image capturing process. Secondly, the described solution offers an intuitive way for organizing images right upon creation thereof. The user of the device executing the invention probably has a kind of a storyline or at least a conception about the different relations between the images in her mind while creating the images, and via the presented technique such relations can be substantially simultaneously captured with the images. Thirdly, the invention can be implemented straightforwardly by utilizing means, both software and hardware, which is usually already present in the executing device. Correspondingly, almost any device capable of digital image/video creation is a suitable platform for the invention.

In an embodiment of the invention a user of a camera or camera phone programmed according to the principles of the invention takes a photo image of his home and surroundings thereof. While the camera application is running in his camera phone the user takes a photo, defines a link area thereto and captures a subsequent photo that is then linked to the link area. Such method is repeated until all the images the user had in his mind have been taken with the necessary link information to enable further convenient, organized contemplation of the digital photo album.

In another embodiment the user traverses through his digital photo album created by following the principles of the invention and utilizes the existing links and available supplementary information to cleverly control the procedure over a visual interface.

### BRIEF DESCRIPTION OF THE DRAWINGS

In the following, the invention is described in more detail by reference to the attached drawings, wherein

FIG. 1 illustrates a first photo image on a display of the executing device during the image capturing process in accordance with a first embodiment of the invention.

FIG. 2 depicts a subsequent photo image.

FIG. 3 discloses various link forms and a chain formation.

FIG. 4 depicts the utilization of a device Ul in the first embodiment.

FIG. 5 is a flow diagram of one option for carrying out the method of the first embodiment.

FIG. 6 depicts image chain navigation according to a second embodiment of the invention.

FIG. 7 is a flow diagram of one option for carrying out the method of the second embodiment.

FIG. 8 is a block diagram of an electronic device adapted to execute the methods of the first and/or second embodiments.

### DETAILED DESCRIPTION

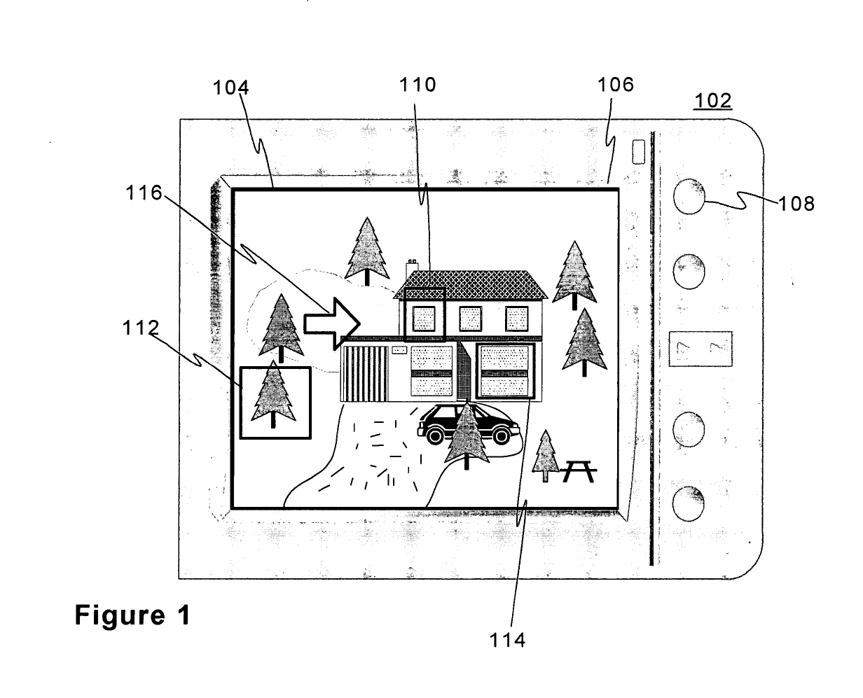

FIG. 1 shows the set-up of the first embodiment of the invention. A back plate of digital camera 102 comprises touch screen 106 displaying photo image 104 taken by the user about his home yard. Touch screen 106 enables housing a rather moderate amount of dedicated control buttons, switches and knobs 108 to the outer surface of camera 102 due to its own versatile functionality both as a display and button(s), and is thus preferable, not obligatory though, choice for providing a sophisticated Ul for limited space(s).

The user has, prior to ending up at the visualized scenario, launched the photo capturing application in his camera. The user has then targeted the camera towards his private house and home yard via the viewfinder, e.g. screen 106 displaying live signal acquired through the camera lens, and pressed button 108 to trigger the photo shoot. The photo image remains (in other words is maintained by the application) at least for a predetermined period on screen 106 for the user's review and optional further editing. For example, there may be options shown as text or icons on top of the figure, referring to either the device buttons or the touch-sensitive surface below and describing the ways the photo just taken may be edited including also metadata editing. One option may state “Link to another image”, which the user has in this case selected. Then the user has utilized his finger or a real stylus etc to mark those areas on the image that he wanted to act as links to another images. Marking refers to painting a route between start and end points on the basis of which the photo capturing application can determine the preferred area based on a number of predefined rules. E.g. the application may extrapolate a rectangle or a round form from the free-hand control data that it then locates on top of the image as a link area. Naturally if the user defines only a single pixel on the image by just pressing screen 106 once, the application may automatically resize the link area to provide a usable-sized link for future use. Theoretically though, a minimum route measures only a single pixel or other predefined minimum size element of the image, so does the area. Respectively, maximum route/area is limited by the overall size of the image. Now we move on to the particular occasion depicted in the figure.

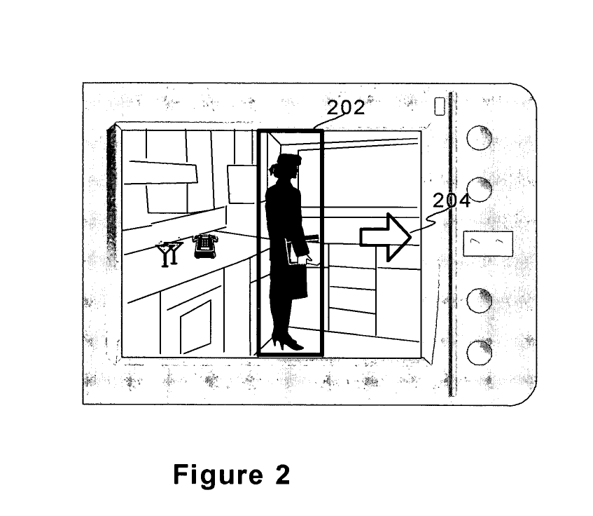

In the event of the first embodiment the user defines four link areas marked by the application with three rectangles 110, 112, and 114, and one arrow 116. The application may offer a predetermined form, e.g. a rectangular one, for the links that the user may then change into a more specific representation of the nature of the link. Another option is to show to the user upon link area definition an option list from which the user may select a preferred link form and optional other modifiers to be inserted in the marked area. In FIG. 1 rectangular links symbolise a conceptually more direct link, e.g. a more detailed view, to the topic of the encompassed area whereas the arrow represents movement to the indicated direction, i.e. the object image behind that link does not necessarily stand out from the current image at all. By exploiting the links behind the link areas the person who is later inspecting the image collection may avoid checking images that seem not to be of any interest and, at the same time, surf from an image to another through a natural route. In FIG. 1 image 104 includes link area 114 defining a window of the house. The image behind the link visualises the house's kitchen residing behind the window, see FIG. 2.

The kitchen view can be further used as a source for links to other images, see rectangle 202 enclosing the user's wife thus probably leading to a more specific image of hers, and arrow 204 directing to a view of the right side of the kitchen from the taking point of the image, for example.

One could question the possible disturbing effect of different link areas and additional link information embedded in the images while looking at them. As the link information is preferably inserted in the images or stored separately as metadata, it can be either switched on or off easily (through a button press etc) during the navigation process whenever desired. That way also the applications not supporting the embedded link information could be used to view the images as they could just omit the metadata that they cannot interpret or utilize.

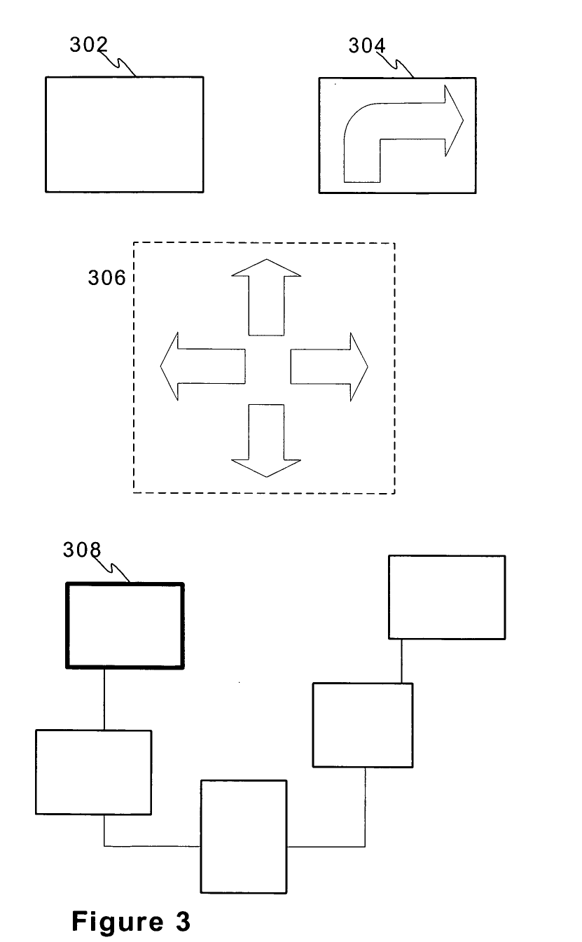

A number of exemplary options for links' outlook and modifiers are shown in FIG. 3. Basic square link 302 may be typically used as a snapshot for the subsequent image of a topic shown in the middle. Square link with curved arrow 304 could be used as a backtracking link (directional link), which refers to the previous, e.g. a more general, image from the more specific image.

Arrows 306 may also reflect the direction into which the associated image is targeted. In addition to different shapes, colours may be used to individualize the links: e.g. yellow rectangle may refer to an image with further image links and a green one to an image without subsequent links. Finally, the images can be represented as a structure of miniature/symbolic versions thereof 308 even on top of a single image to visualize and ease navigation and also to enable direct jumps to distant images in the same chain e.g. for link definition without need to wade trough the other images in the middle. Currently selected image may be marked with a bold borderline. While continuing the image capturing process the visualized structure can be updated continuously to correspond the expanding image chain.

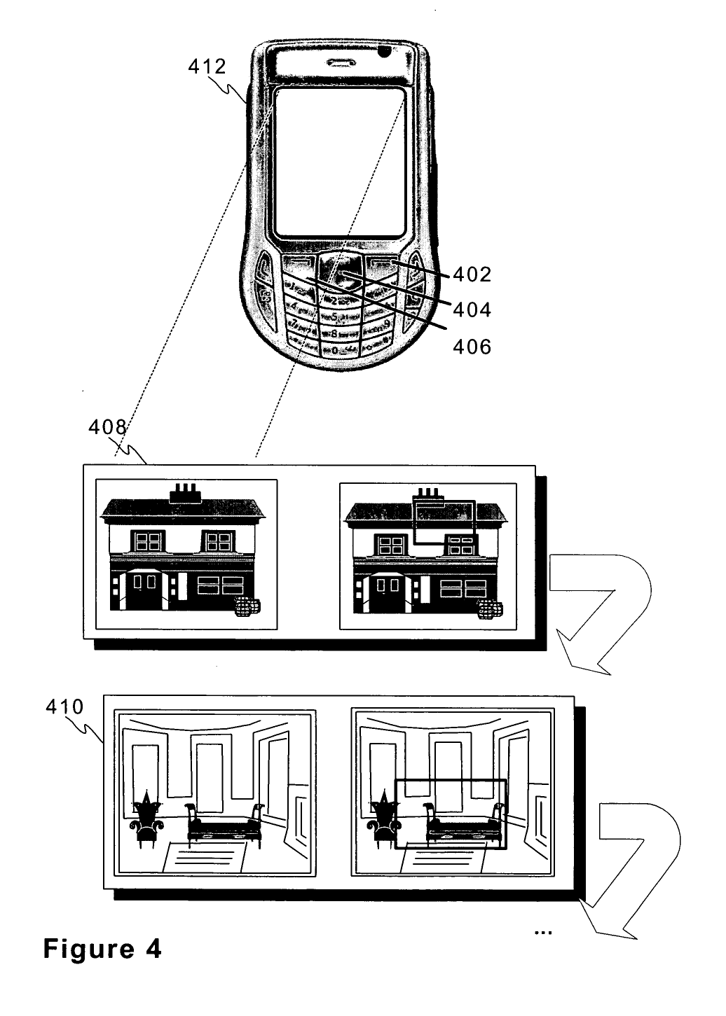

As shown in the foregoing paragraphs, a major benefit of the invention is reached through immediate structuring of images via links and additional data while still continuing taking further images with the image capturing application running. This type of direct image manipulation is flexibly supported by a touch screen/pad, joystick, mouse, track ball, rocker key, track point etc type control means in addition to more traditional keys and switches. See FIG. 4 for an example. A modern mobile terminal 412 is equipped with a relatively high-resolution, e.g. 640×320 pixels with approximately 60 000 colours supporting screen, a megapixel class camera and multiple control buttons 402, 406 deposited on a keypad with rocker key arrangement 404 that enables a concrete linkage of user input and directional control.

One option for image capturing process proceeds from the user's standpoint as follows: 1. Take a first photo image by pressing button 402; see reference numeral 408 and the image on the left. 2. Define a new link area on the image by utilizing rocker key 404 and button 402; see the image on the right. 3. Take a second photo image being the target for the link by pressing button 402, see numeral 410 and image on the left. 4. Define a new link area on the second image (see the last image on the bottom right corner) by utilizing rocker key 404 and button 402, or backtrack to the first image by pressing button 406 and define a second link area there by utilizing rocker key 404 and button 402. 5. Take a photo image corresponding to the target link area defined during step 4, etc.

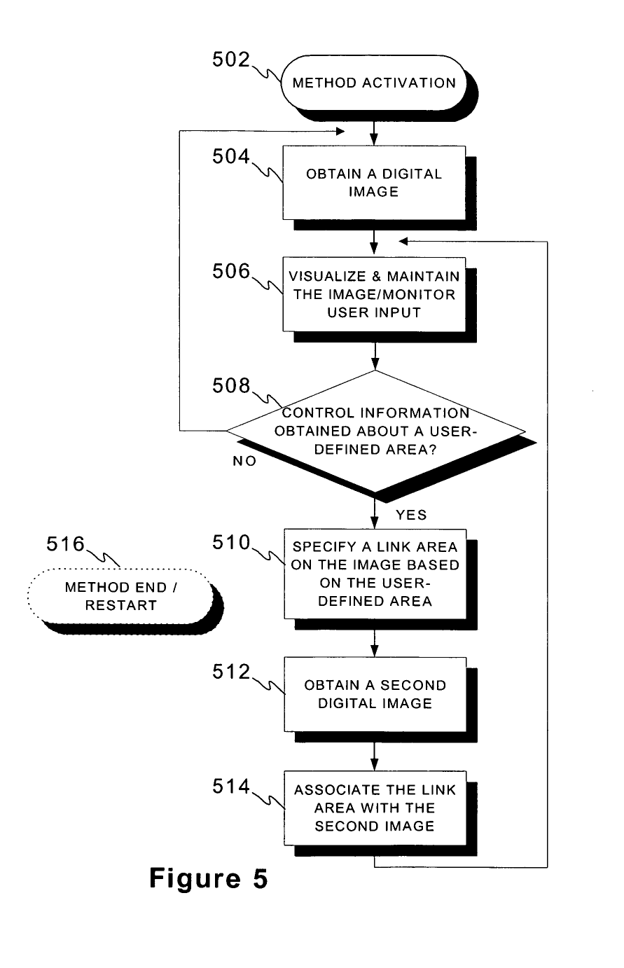

A flow diagram disclosing the first embodiment of the invention is shown in FIG. 5. At a method start-up phase, see step 502, the image capturing application is started and initialised in the executing device, i.e. necessary parameter values (image resolution & type, exposure, destination files' location, shoot style: single images, serial shooting, video, etc) are defined by the user or set automatically based on predefined values (“preferences”). If the display of the device is used as a camera viewfinder, the display shall be configured to a show real-time signal acquired through the camera for targeting the shots. In step 504 an image is obtained either by an internal or external camera as a response to a button press by the user or expiration of a timer, for example. In visualization/monitoring step 506 the obtained image is shown to the user via the display; the image is preferably maintained or “freezed” on the display so as to enable the user to analyse it and define through the Ul a number of areas funnelling into another images. It is possible to let the user define multiple areas at once before determining the plurality of images behind the corresponding links but in this exemplary solution the process is made more serial like for increased clarity and after defining a single link area on an image, also the corresponding target image is to be obtained. Thus, upon receiving control information about a user-defined area, which is checked in step 508, an appropriate link area is specified 510, i.e. the form and type of the link to be inserted to a central link database or as metadata to each image are determined based on control commands by the user or on stored predefined settings. Step 510 may also contain receiving additional control input from the user. Meanwhile, if the control information does not indicate defining any link areas (e.g. it instructs the application to obtain a subsequent image) execution re-starts from step 504. In step 512, a second image acting as the link target is obtained and in step 514, the link area is associated with the second image and the link information including e.g. link type (unidirectional, multi-directional, etc) is stored into the image file(s) or as a separate optional data file that is either an aggregate one or an image-specific. With multi-directional links and particularly if image-embedded link information is used, either the link source image or both the source and target images could share link information. Although the images have in this example been acquired through a digital camera, a similar kind of algorithm could be used for linking images received through other means. As an alternative to capturing also the second image in real time with the camera etc, the second image may be a previously existing stand-alone image or forming a part of an older image chain, in which case the older chain is now updated by addition of the image obtained in step 504.

Now the execution of the method reverts to step 506 wherein the newly taken (or at least addressed) image is shown to the user for area determining purposes. Alternatively, at this stage the user may by e.g. pressing a certain control button backtrack to the first image and continue defining further areas there. As the image capturing application is in many cases executed continuously, the user can close/re-start it 516 (or place it into background if multitasking is supported) by pressing a predefined control button or selecting a corresponding menu item in any preferred instant (during any step), for example. It is clear to a person skilled in the art that additional steps may be introduced to the process and the order and meaning of different steps can be respectively cultivated to better fit any desired purpose.

In the second embodiment of the invention, a plurality of images have already been obtained by utilizing the afore-explained method and now the photo album is navigated either separately or in connection with further image capturing by utilizing the structures derivable from the links. As hinted hereinbefore, the link information (area, target, etc) may be stored per image file as embedded/separate data or per device/application as a centralized database, or as a combination of both. In the former case an image chain overall structure may be constructed by checking the metadata fields/files of related images (images in the same folder, in the same device, etc) through one at a time and building the resulting chain structure. In the latter option necessary information about the links may be first read from the database and then used for constructing the representation of image chain(s).

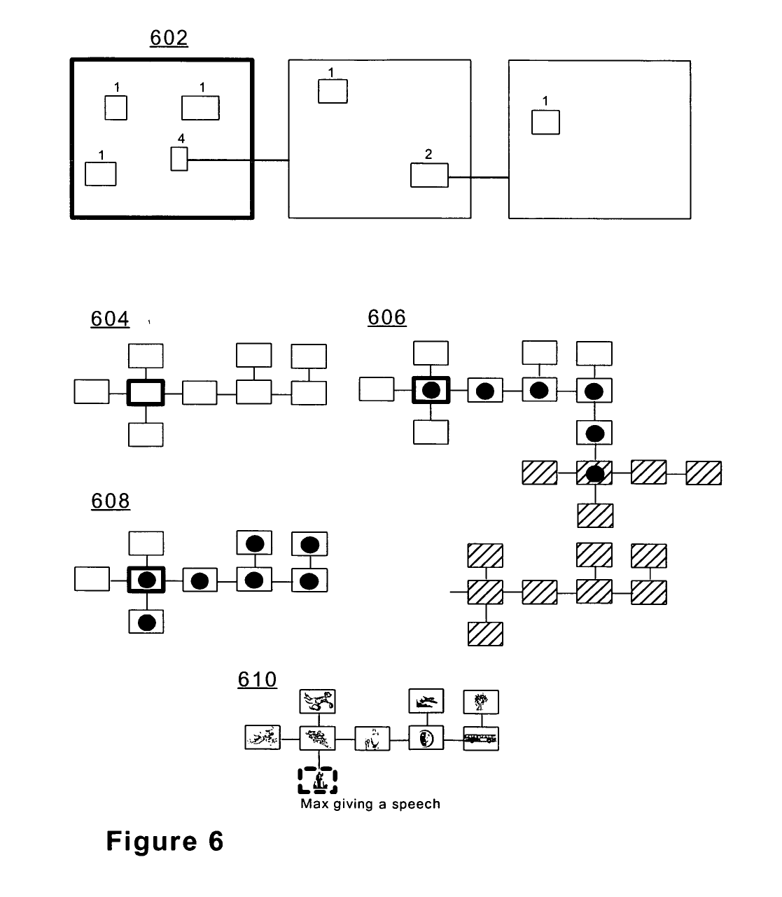

FIG. 6 visualizes different ways to represent the relations between images linked together either directly or via intermediate images. The representations are also suitable to be depicted on top of other images, e.g. a currently selected (e.g. “active” or other, explicitly specified) image or the last obtained image during the image capturing process, for example. Reference numeral 602 points at a representation technique in which a selected image is displayed as a rectangular frame including the link areas with a numerical modifier indicating the (total) number of images found behind each link. One of the link areas is then selected by the user via the Ul and the images behind that link are drawn close to the original selected image with lines indicating the link connections between the three images located next to each other. Alternatively all the further images can be visualized automatically if containing further links (otherwise, no reason to visualize them further). The system may visualize only a single image or multiple images at a time depending on a number of factors: the display size, resolution, and the total number of images to be visualized, for example. Currently active or otherwise selected image can be drawn with bolded borderline (shown) or with other distinctive feature such as colour.

The simplest way to represent the building blocks of an image chain can be found from a position indicated by reference numeral 604. Images are drawn as rectangles and links as lines between those thus forming an image map. This is similar to the structure in FIG. 3. Here, however, all the rectangles are of same size to provide easier navigability in sense of a regular “grid” of images.

Image date (capturing, editing, accessing, etc) can be visualized, in addition to text, through different graphic patterns, see image chains in position 606.

In another option, see numeral 608, the image map shows the latest navigation route as dots within the image rectangles.

Option 610 includes thumbnails (a sample or a reduced size version) of actual images embedded in the image symbols and an image text “Max giving a speech” of an image (dotted border line) selected by the user via the Ul.

A feature common to all the above visualization options is the somewhat instantly perceivable structure that easies navigation and search procedures. The user can, for example, select/activate a certain image from the visualized structure by point-and-click type method (or by directly pressing the corresponding location on the display in the case of a touch-sensitive model) to see further information particularly related to that specific image, and maybe proceed with another click to open the image in full size.

In the previous examples the shape of image symbols (rectangular, round, etc) was not exploited due to clarity. Alternatively, a shape of an image symbol could be configured to reflect some characteristic feature thereof being, for example, linked to the size, resolution, preferred metadata field (value), etc.

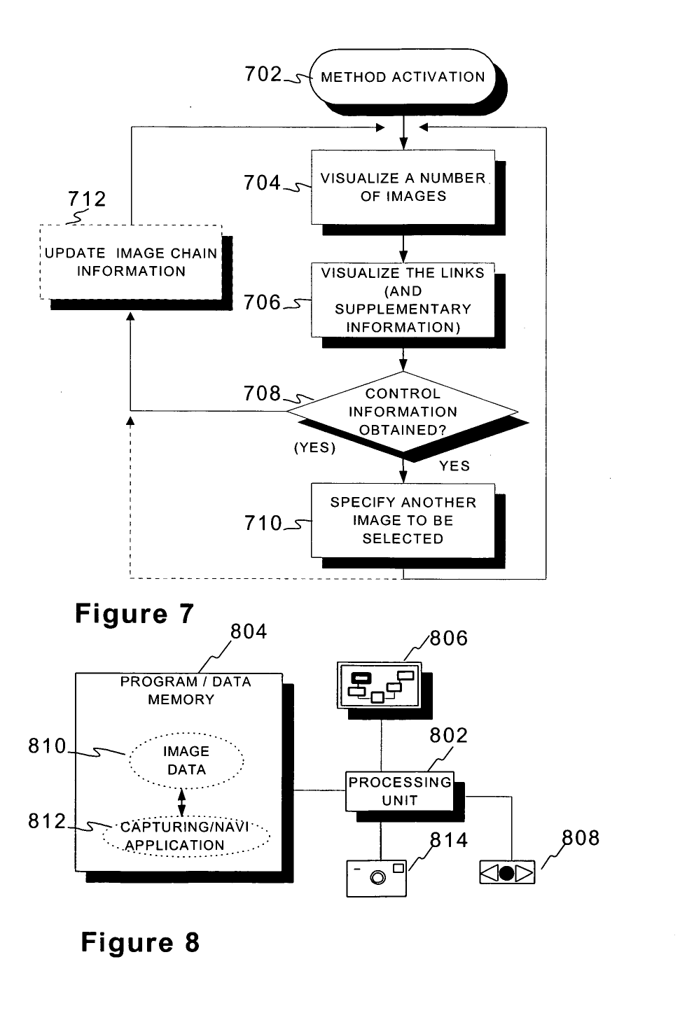

The diagram of FIG. 7 discloses one example of carrying out the image chain visualization method as explained above for image chain navigation, examination and optionally also management. During method activation step 702 initial settings for image visualization are taken into use by the executing device as in the corresponding step of FIG. 5 and the user is prompted to determine the location of target images to be examined, for example. In step 704 a number of images, e.g. image file(s) in a certain folder or image(s) forming a chain via links (chains can be tracked and reconstructed by inspecting the link information embedded in images or stored separately) and/or bearing common parameter values (e.g. metadata values) meeting the search terms given by the user are visualized on a display device. The images can be visualized via symbols, e.g. via different shapes, or as such either in original or amended size, e.g. as thumbnails. In step 706 the links between at least one image that has been selected and other images belonging to the number of images are visualized, optionally with additional information. Link visualization may be performed through different shapes of symbols like border line type link areas on top of an image, in which case the link area may also be used to symbolize the target image in addition to the link and vice versa, or through actual image symbols not forgetting lines/arrows between images or symbols thereof. For example, the selected image may be shown in the foreground as a full-size/larger image optionally consuming the whole display area whereas the related linked images are only shown as miniature/symbolic versions or link areas next to it or on top of it. The selected image may be shown with more information than the rest of the images, i.e. metadata related to the selected image such as image name is shown to the user. The selected image is either manually determined by the user or automatically determined by the device based on e.g. metadata (date: latest image, usage date: latest image viewed, creation date: oldest/first image, parameter: user-defined image for representing a certain image chain, etc) or user preference information.

In step 708 control information is gathered from the user via the Ul. The control information can include image selection/de-selection commands, directional navigation commands, metadata visualization on/off-commands, image chain reorganization commands, etc. In step 710 another image is specified to be selected next on the basis of the control information indicating a new selection. Execution reverts to step 704 with the freshly defined selected image. Ghost step 712 (accessible through steps 708 and 710 in the figure) refers to optional image chain update measures like different reorganization processes that occur in response to the received control information not necessarily indicating change of the selected image. E.g. different metadata fields are switched on/off in the visualization, or the user manually organizes and edits the images (inserts new ones, deletes existing ones, changes metadata, etc) and/or links between them. Method execution ends when the user commands it via the Ul (not shown).

FIG. 8 shows a block diagram of one option of an electronic device such as a digital camera, a PDA (Personal Digital Assistant), or a wireless communications device, e.g. a mobile terminal, adapted to execute the method of the invention. The device includes processing unit 802 in a form of a processor, a programmable logic chip, a DSP, a micro-controller, etc to carry out the method steps as set down by the circuit structure itself or image capturing/navigation application 812 stored in memory 804. Memory 804, e.g. one or more memory chips, a memory card, or a magnetic disk, further comprises space 810 to accommodate images, metadata such as link information, etc. It is also possible that memory comprising the images is separate (e.g. a memory card inserted in the executing device) from the memory comprising application 812 logic. Control input device 808, by which it is referred to the actual control means in the hands of the user or just appropriate interfacing means, may include a mouse, a keyboard, a keypad, a track ball, a pen, a pressure sensitive touch pad/screen, optical and/or capacitive sensors, etc. A display 806 refers to a common computer display (crt, tft, lcd, etc.) or e.g. different projection means like a data projector. Alternatively, display 806 may only refer to techniques for interfacing/controlling the display device that is not included in the device as such. Yet, display 806 may refer to additional software that is necessary for controlling data visualization in accordance with the invention. A camera through which the photo images can be captured is included in the device as an internal module or merely connected to the device via wired or wireless connecting means (physical connector, IR/RF transceiver, etc) in which case data input device 814 only refers to means necessary to enable faultless reception of images from the connected device.

In addition to data elements, the code for image capturing/navigation application 812, generally called a computer program, to carry out the method steps of the invention may be provided to the executing device on a separate carrier medium such as a memory card, a magnetic disk, a cd-rom, etc.

The scope of the invention is found in the following claims. Although a few examples were given in the text about the invention's applicability and feasible implementation, the purpose thereof was not to restrict the usage area of the actual fulcrum of the invention to any certain occasion, which should be evident to skilled readers.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising
obtaining a digital image captured via a camera,
visualizing the image on a display,
obtaining control information at least about a user-defined area on the visualized image,
specifying on the basis of the user-defined area a link area on the image,
obtaining another digital image, and
associating the link area with said another image.

2. The method of claim 1, wherein the visualized image is maintained on the display for the user's review and area definition.

3. The method of claim 1, further wherein said another image is visualized on the display, control information about a user-defined area on said another image is obtained, and a link area on said another image is specified.

4. The method of claim 1, further wherein control information about a second user-defined area on the visualized image is obtained and a second link area on the visualized image is specified.

5. The method of claim 1, wherein said control information defines a route between user-defined start and end points.

6. The method of claim 1, wherein said control information defines a single pixel on the display.

7. The method of claim 1, wherein the size of the link area is substantially matched with the size of the user-defined area.

8. The method of claim 1, wherein the form of the link area is user-selectable by the user.

9. The method of claim 1, wherein the form of the link area is determined based on predefined rules.

10. The method of claim 1, wherein a number of modifiers for the link area are listed to the user on the display in connection with the link area definition.

11. The method of claim 1, wherein at least part of an image chain is visualized on the display.

12. The method of claim 1, wherein the link area is visualized on the display.

13. The method of claim 1, wherein the visualized image is stored with embedded link information.

14. The method of claim 1, wherein both the visualized image and link information thereof are stored, the link information being stored separately from the visualized image.

15. The method of claim 1, wherein information about a link between said visualized image and said another image is stored as embedded in both the visualized and another images.

16. The method of claim 1, where in the case of a unidirectional link between said visualized and said another image, the image acting as a source of the link is exclusively provided with the link information.

17. The method of claim 1, wherein said visualized image represents a frame of a video clip, a video clip, or an audio clip.

18. An apparatus comprising
a data input device for obtaining a digital image captured via a camera, and
a display for visualizing the image,
a control input device for receiving control information at least about a user-defined area on the visualized image, and
a processing unit configured to specify, on the basis of the user-defined area on the visualized image, a link area on the visualized image to be associated with at least one another image.

19. The apparatus of claim 18, configured to maintain the visualization of the image until at least one of the following conditions applies: a predetermined period expires, and the control information is received.

20. The apparatus of claim 18, configured to visualize the link area.

21. The apparatus of claim 18, configured to associate said link area with said at least one another image captured subsequent to the visualized image.

22. The apparatus of claim 18, wherein said data input device, display, control input device, and processing unit are configured to operate during the execution of an image capturing application.

23. The apparatus of claim 18, further configured to visualize said another image, to receive control information at least about a user-defined area on said another image, and to specify, on the basis of the user-defined area on said another image, a link area on said another image to be associated with a further image.

24. The apparatus of claim 18, further configured to receive control information about a second user-defined area on the visualized image and to specify, on the basis of the user-defined area, a second link area on the visualized image to be associated with a further image.

25. The apparatus of claim 18, further configured to visualize a plurality of images and links existing between them.

26. The apparatus of claim 18, further configured to receive control information to navigate between a number of images having links between them.

27. The apparatus of claim 18, wherein said data input device comprises a camera or a connector therefor.

28. The apparatus of claim 18, wherein said control input device include at least one of the following: a roller button, a touch pad, and a touch screen.

29. The apparatus of claim 18, wherein said display include a touch screen.

30. The apparatus of claim 18 that is a mobile station or a digital camera.

31. A method comprising
providing at least one image chain, said at least one image chain comprising multiple digital images and link information about a number of links between them, each image of the image chain being linked to at least one another image of the image chain,
visualizing a number of images belonging to the image chain, said number of images including a selected image determined by the device or indicated by a user input signal,
visualizing the links between at least said selected image and other images belonging to the chain, and supplementary information relating to at least said selected image or a link having the selected image as one end point thereof,
obtaining control information from a corresponding user input signal, and
specifying on the basis of the control information a second image of the chain to be selected subsequently.

32. The method of claim 31, wherein one end of a link refers to a sub-area of an image and the other end to another image.

33. The method of claim 31, wherein one or more images are visualized as symbols.

34. The method of claim 33, wherein a symbol includes a thumbnail of the corresponding image.

35. The method of claim 31, wherein the supplementary information refers to at least one of the following: a date relating to the image, navigation history, an image text, a parameter value, the number of images located behind a link, currently selected image, and dimensions of an image.

36. The method of claim 31, wherein control information indicates at least one of the following: selection or de-selection of a visualized image, selection of a link, insertion of an image to the chain, deletion of an image from the chain, directional information, and a search term.

37. The method of claim 31, wherein a link is visualized with a unidirectional or a multidirectional arrow.

38. The method of claim 31, wherein a link between the selected image and another image is visualized as a link area on top of the selected image.

39. The method of claim 31, wherein the link information is retrieved from metadata embedded in one or more images belonging to the image chain or from one or more separate data entities of the image chain.

40. The method of claim 35, wherein the number of images located behind a link is represented next to the link.

41. The method of claim 31, further updating link or supplementary information in relation to one or more images belonging to the image chain based on the control information.

42. The method of claim 31, wherein the image chain is provided as a response to an image search based on a search term received from the user.

43. The method of claim 31, wherein said device is a digital camera or a mobile terminal.

44. The method of claim 31, wherein one or more images belonging to the image chain are obtained by the method as defined by any of claim 1.

45. The method of claim 31, which is performed by the image capturing application of an electronic device.

46. The use of a method as defined by claim 31 for navigating an image chain formed by using a method as defined by any of claim 1.

47. An electronic device capable of storing digital images comprising
a data input device for obtaining digital images,
a display for visualizing digital images to a user, and
a control input device for receiving control information from the user,
a processing unit configured to visualize through said display a number of digital images belonging to an image chain to a user, said image chain comprising multiple digital images and link information about a number of links between them, each image of the image chain being linked to at least one another image of the image chain and said number of images including a selected image determined by the device or chosen by the user,
further configured to visualize the links between at least said selected image and other images belonging to the chain, and supplementary information relating to at least said selected image or a link having the selected image as one end point thereof,
further configured to obtain control information from the user through said control input device, and
configured to specify on the basis of the control information a second image to be selected subsequently.

48. The electronic device of claim 47, configured to visualize one or more images as symbols.

49. The electronic device of claim 48, wherein a symbol includes a thumbnail of the corresponding image.

50. The electronic device of claim 47, wherein the supplementary information refers to at least one of the following: a date relating to the image, navigation history, an image text, a parameter value, the number of images located behind a link, currently selected image, and dimensions of an image.

51. The electronic device of claim 47, wherein said control information indicates at least one of the following: selection or de-selection of a visualized image, selection of a link, insertion of an image to the chain, deletion of an image from the chain, directional information, and a search term.

52. The electronic device of claim 47, configured to visualize a link with a unidirectional or a multidirectional arrow.

53. The electronic device of claim 47, configured to visualize a link between the selected image and another image as a link area on top of the selected image.

54. The electronic device of claim 47, configured to retrieve the link information from metadata embedded in one or more images belonging to the image chain or from one or more separate data entities of the image chain.

55. The electronic device of claim 50, configured to represent the number of images located behind a link next to the link.

56. The electronic device of claim 47, further configured to update link or supplementary information in relation to one or more images belonging to the image chain based on the control information.

57. The electronic device of claim 47, configured to visualize said number of digital images as a response to an image search based on a search term received from the user.

58. The electronic device of claim 47, configured to obtain one or more images belonging to the image chain by using the method of claim 1.

59. The electronic device of claim 47 that is a mobile terminal or a digital camera.

60. A computer program product comprising code stored on a readable medium for execution by a processing unit for carrying out the method of claim 1.

61. The computer program product of claim 60, wherein the readable medium is a memory card, a magnetic disk, or a cd-rom.

62. An apparatus comprising
means for obtaining a digital image captured via a camera, and
means for visualizing the image
means for receiving control information at least about a user-defined area on the visualized image, and
means for specifying, on the basis of the user-defined area on the visualized image, a link area on the visualized image to be associated with at least one another image.

63. The apparatus of claim 62, configured to maintain the visualization of the image until at least one of the following conditions applies: a predetermined period expires, and the control information is received.
